(19) United States
(12) Patent Application Publication
(10) Pub. No.: US 2018/0229259 A1
(43) Pub. Date: Aug. 16, 2018

(54) MATERIAL COATING APPARATUS AND ITS CONTROL METHOD

(71) Applicants: Boe Technology Group Co., Ltd., Beijing (CN); Beijing Boe Display Technology Co., Ltd., Beijing (CN)

(72) Inventors: Lianzhu Shao, Beijing (CN); Lei Cheng, Beijing (CN); Xingkai Zhang, Beijing (CN); Naizhi Sun, Beijing (CN)

(21) Appl. No.: 15/513,671

(22) PCT Filed: Aug. 10, 2016
(86) PCT No.: PCT/CN2016/094363

§ 371 Date: Mar. 23, 2017

(30) Foreign Application Priority Data
Jan. 22, 2016 (CN) 201610045060.4

(51) Int. Cl. B05C 11/10

(52) U.S. Cl. CPC B05C 11/1013

(57) ABSTRACT

A material coating apparatus includes a storage chamber, a gas pressure chamber, a flow regulating rod, a gas pressure regulating device and a gas supply source. The flow regulating rod runs through the storage chamber and is provided with a regulating head, and is connected to a piston in the gas pressure chamber. An output of the gas pressure regulating device is connected to the gas pressure chamber; an input of the gas pressure regulating device is connected to the gas supply source and is used to receive a preset material flow rate of the outlet port. The gas pressure regulating device then converts the preset material flow rate into a preset gas pressure value of the gas pressure chamber matching with the preset material flow rate and then control the gas flow rate outputted from the gas supply source to the gas pressure chamber.

### RELATED APPLICATIONS

The present application claims the benefit of Chinese Patent Application No. 201610045060.4, filed Jan. 22, 2016, the entire disclosure of which is incorporated herein by reference.

### FIELD OF THE INVENTION

The present disclosure relates to a technical field of display manufacture, and in particular relates to a material coating apparatus and its control method.

### BACKGROUND OF THE INVENTION

A TFT-LCD (Thin Film Transistor Liquid Crystal Display) as a flat panel display device has become widely used in the high performance display technical field due to its small volume, low power consumption, lack of radiation, low production costs, etc.

An array substrate of a TFT-LCD includes a display area and a non-display area surrounding the display area. The non-display area is used to arrange electronic structures such as a drive circuit, data leads, data terminals, and the like. In order to protect elements and wirings in the circuit structure, a surface of the circuit structure is generally coated with silica gel so that the circuit structure will be protected from the external erosion factors such as water, oxygen, and dust, thereby decreasing the aging rate.

An existing silica gel coating device as shown in FIG. 1 includes a storage chamber 100 containing silica gel. In addition, the silica gel coating device also includes a knob regulating valve 102 and a flow regulating rod 103 connected to the knob regulating valve 102 in a closed chamber 101. By rotating the knob regulating valve 102 manually, the flow regulating rod 103 can be driven to move upwards and downwards along the arrow direction so that the size of the outlet port 111 of the storage chamber 100 can be adjusted so as to adjust the flow rate of the silica gel.

However, because the knob regulating valve 102 needs to be adjusted manually, the regulating accuracy is low so that there might be a large deviation between the finally coated silica gel amount and the preset silica gel amount, resulting in uneven coating and thus lowering the product quality. When the coating is poor, the silica gel coating device needs to be shutdown and the knob regulating valve 102 will be adjusted. Additionally, the silica gel coated poorly will be removed and the coating must be performed again. Therefore, the time of the manufacture process will be longer and the production efficiency will be lowered.

### SUMMARY OF THE INVENTION

The embodiments of the present disclosure provide a material coating apparatus and its control method which can improve the control accuracy of silica gel coating.

In an aspect of the present disclosure, a material coating apparatus is provided, which includes: a storage chamber for containing the material, a gas pressure chamber, a flow regulating rod running through the storage chamber, a gas pressure regulating device and a gas supply source; wherein the flow regulating rod is provided with a regulating head at an end near the outlet port of the storage chamber, which is used to adjust the size of the outlet port; an end of the flow regulating rod facing away from the outlet port is connected to a piston in the gas pressure chamber; wherein an output of the gas pressure regulating device is connected to the gas pressure chamber, an input of the gas pressure regulating device is connected to the gas supply source and is used to receive a preset material flow rate of the outlet port. The gas pressure regulating device is configured to convert the preset material flow rate into a preset gas pressure value of the gas pressure chamber matching with the preset material flow rate, and to control the gas flow rate from the gas supply source to the gas pressure chamber according to the preset gas pressure value.

According to an aspect of the present disclosure, the gas pressure regulating device includes a memory, a data processor and a pressure regulating valve. The memory is used to store the preset material flow rate, the preset gas pressure value and the matching relationship between the preset material flow rate and the preset gas pressure value. The data processor is connected to the memory, and can obtain the preset gas pressure value matching with the preset material flow rate based on the preset material flow rate. The pressure regulating valve is connected to the data processor, the gas supply source and the gas pressure chamber, and is configured to control the gas flow rate from the gas supply source to the gas pressure chamber based on the preset gas pressure value.

According to an aspect of the present disclosure, the gas pressure regulating device further includes a gas pressure acquisition device and a gas pressure calibrator. One end of the gas pressure acquisition device is connected to the gas pressure chamber and the other end of the gas pressure acquisition device is connected to the gas pressure calibrator. The gas pressure acquisition device is used to acquire the gas pressure value in the gas pressure chamber and feed it back to the gas pressure calibrator. The pressure regulating valve can be connected to the data processor through the gas pressure calibrator. The gas pressure calibrator is used to receive the gas pressure value fed back by the gas pressure acquisition device and can calibrate the flow rate of the output gas pressure of the pressure regulating valve based on the preset gas pressure value obtained by the data processor so that the gas pressure value in the gas pressure chamber can be matched with the preset gas pressure value.

According to an aspect of the present disclosure, the material coating apparatus further includes a barometer. The barometer is connected to the gas pressure acquisition device and is used to display the gas pressure value acquired by the gas pressure acquisition device.

According to an aspect of the present disclosure, the gas pressure regulating device further includes a touch control display panel which is used to input and display the preset material flow rate.

According to an aspect of the present disclosure, the material coating apparatus further includes a gas cylinder and a material supply chamber. One end of the material supply chamber is connected to the gas cylinder, the other end of the material supply chamber is connected to the storage chamber, and the material supply chamber is used to supply material to the storage chamber by the action of the gas cylinder.

According to an aspect of the present disclosure, the material coating apparatus further includes a nozzle connected to the outlet port; the nozzle is provided with a first sealing plug at a side near the outlet port; the first sealing plug is provided with a first through hole for passing material at a position corresponding to the outlet port.

According to an aspect of the present disclosure, the regulating head is tapered; at a side near the regulating head, the opening of the first through hole is inverted tapered, and the tapered shape is matched with the inverted tapered shape.

According to an aspect of the present disclosure, the regulating head is a tubular structure and the regulating head is provided with a regulating hole in the side wall.

According to an aspect of the present disclosure, the storage chamber is provided with a second sealing plug at the outside at a position corresponding to the flow regulating rod. The second sealing plug is provided with a second trough hole which can allow the flow regulating rod to pass through.

According to an aspect of the present disclosure, the piston is connected to a spring at a side facing away from the flow regulating rod; the other end of the spring is connected to the top of the gas pressure chamber.

According to an aspect of the present disclosure, the piston is provided with a first guide bar at a side facing away from the flow regulating rod; the top of the gas pressure chamber is provided with a second guide bar opposite to the first guide bar. The first guide bar and the second guide bar extend into the spring from two ends of the spring respectively, which are used to stop the spring to be further compressed when the first guide bar and the second guide bar contact each other.

According to another aspect of the present disclosure, a control method is provided which is used to control the above discussed material coating apparatuses, including the following steps: in non-coating phrase, the regulating head of the flow regulating rod can run through the outlet port of the storage chamber and close the outlet port; in coating phase, the gas pressure regulating device receives a preset material flow rate of the outlet port, and converts the preset material flow rate into a preset gas pressure value of the gas pressure chamber matching with the preset material flow rate and then controls the flow rate of the gas outputted from the gas supply source based on the preset gas pressure value; under the action of the gas with the preset gas pressure value in the gas pressure chamber, the piston can drive the flow regulating rod to move in a direction away from the outlet port. The regulating head can be used to control the opening size of the outlet port.

According to an aspect of the present disclosure, when the gas pressure regulating device includes a memory, a data processor, a gas pressure acquisition device, a gas pressure calibrator and a pressure regulating valve, in the coating phase, the method includes: storing the preset material flow rate, the preset gas pressure value and the matching relationship between the preset material flow rate and the preset gas pressure value in the memory; obtaining a preset gas pressure value matching with the preset material flow rate based on the preset material flow rate by the data processor; acquiring the gas pressure value in the gas pressure chamber and feeding it back to the gas pressure calibrator by the gas pressure acquisition device; receiving the gas pressure value fed back by the gas pressure acquisition device and calibrating the flow rate of the output gas pressure of the pressure regulating valve by the gas pressure calibrator; controlling the flow rate of the gas outputted from the gas supply source to the gas pressure chamber by the pressure regulating valve.

The embodiments of the present disclosure provide a material coating apparatus and its control method. The material coating apparatus includes a storage chamber for containing material, a gas pressure chamber, a flow regulating rod, a gas pressure regulating device and a gas supply source. Specifically, the flow regulating rod runs through the storage chamber and is provided with a regulating head at an end near the outlet port of the storage chamber which is used to adjust the size of the outlet port. An end of the flow regulating rod facing away from the outlet port is connected to a piston in the gas pressure chamber. An output of the gas pressure regulating device is connected to the gas pressure chamber; an input of the gas pressure regulating device is connected to the gas supply source and is used to receive a preset material flow rate of the outlet port. The gas pressure regulating device is configured to convert the preset material flow rate into a preset gas pressure value matching with the preset material flow rate and then control the gas flow rate outputted from the gas supply source to the gas pressure chamber based on the preset gas pressure value.

The regulating head can adjust the size of the outlet port, therefore in the non-coating phase, the regulating head can close the outlet port. In coating phase, the flow regulating rod can move in a direction away from the outlet port, so that the regulating head can control the opening size of the outlet port. Specifically, the operator can input the preset material flow rate required in coating through the gas pressure regulating device. The gas pressure regulating device can control the gas flow outputted from the gas supply source to the gas pressure chamber based on the preset material flow rate so that the gas in the gas pressure chamber outputted from the gas supply source through the gas pressure regulating device can have the above mentioned preset gas pressure value. Under the action of the gas with the preset gas pressure value in the gas pressure chamber, the piston can be controlled to move the flow regulating rod for a certain displacement in the direction away from the outlet port. Because the preset gas pressure value and the preset material flow rate are matched, the actual flow rate of the material through the outlet port is equal to or approximately equal to the preset material flow rate.

In this way, in the coating process of the material coating apparatus, the operator is only required to input the preset material flow rate manually, the actual material flow rate of the outlet port can achieve the preset material flow rate, and there is no need to adjust the material flow rate manually so that the control accuracy of the material coating flow can be improved and the probability of poor coating can be reduced. Besides, due to the increased control accuracy, the downtime caused by the poor coating can be avoided and the production efficiency can be improved.

### BRIEF DESCRIPTION OF THE DRAWINGS

In order to clearly illustrate the embodiments of the present disclosure or the technical solutions in the prior art, the drawings used in the description of the embodiments or the prior art will be briefly explained. Obviously, the drawings in the following description are only some embodiments of the present disclosure. Those skilled in the art can get other equivalent embodiments based on these drawings without creative efforts.

FIG. 1 is a schematic structure view of a silica gel coating device in prior art;

FIG. 2 is a schematic structure view of a material coating apparatus according to an embodiment of the present disclosure;

FIG. 3a is an enlarged schematic view of a regulating head in FIG. 2;

FIG. 3b is a schematic view showing the regulating head in FIG. 3a closes the outlet port;

FIG. 4a is a schematic view of the regulating head shown in FIG. 3a adjusting the size of the outlet port;

FIG. 4b is another schematic view of the regulating head shown in FIG. 3a adjusting the size of the outlet port;

FIG. 5a and FIG. 5b are schematic shape views of longitudinal cross-sections of two different regulating heads;

FIG. 5c is a schematic view of a regulating head provided with a regulating hole;

FIG. 6a is a schematic view showing the regulating head fixed on the flow regulating rod has different displacements under different gas pressure values;

FIG. 6b is a schematic view showing different opening states of the outlet port corresponding to the regulating head under different gas pressure values;

FIG. 7 is a schematic structure view of another material coating apparatus according to an embodiment of the present disclosure;

FIG. 8 is an enlarged view of the portion “A” shown in FIG. 7;

FIG. 9a is a schematic view of an inverted tapered opening of a first through hole in the first sealing plug shown in FIG. 8;

FIG. 9b is another schematic view of an inverted tapered opening of a first through hole in the first sealing plug shown in FIG. 8;

FIG. 10 is a flow chart of a control method of a material coating apparatus according to an embodiment of the present disclosure;

FIG. 11 is a flow chart of a control method of another material coating apparatus according to an embodiment of the present disclosure.

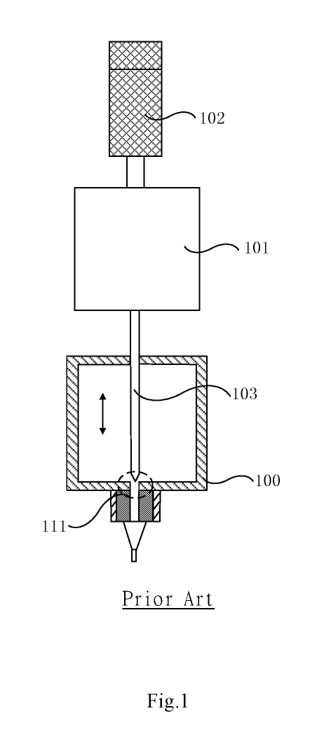

### DETAILED DESCRIPTION OF THE INVENTION

The technical solution according to the present embodiment will be described clearly and thoroughly in conjunction with the drawings. Obviously, the described embodiment is only part of the embodiments of the present disclosure, not all the embodiments of the present disclosure. Based on the embodiments of the present disclosure, those skilled in the art can obtain all the other embodiments without creative efforts and all the other embodiments are within the scope of the present disclosure.

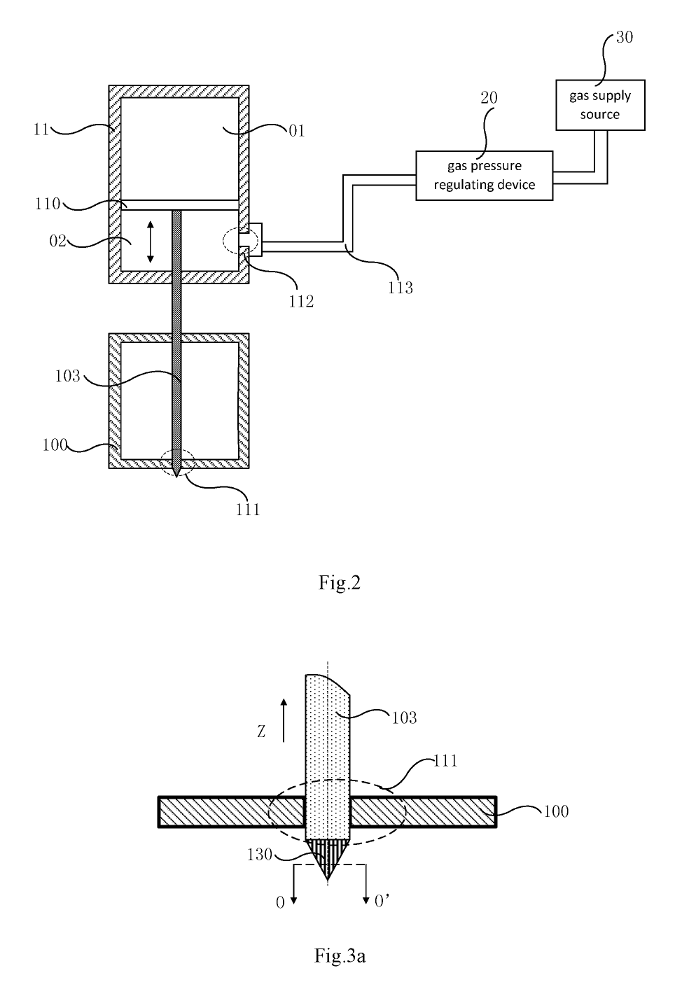

An embodiment of the present disclosure provides a material coating apparatus, as shown in FIG. 2, including a storage chamber 100 for containing material, a gas pressure chamber 11, a flow regulating rod 103, a gas pressure regulating device 20 and a gas supply source 30. In present disclosure, the coating material used by the material coating apparatus is not restricted, and it can be silica gel, sealant and the like.

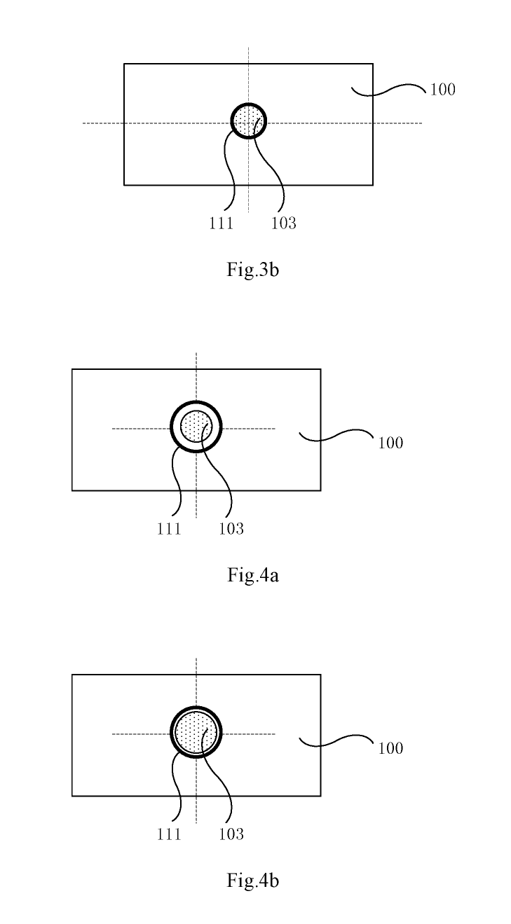

Specifically, the flow regulating rod 103 runs through the storage chamber 100 and is provided with a regulating head 130 (shown in FIG. 3a) at one end near the outlet port 11, which is used to adjust the size of the outlet port 111. The regulating head 130 can be fixed on the flow regulating rod 103 by threaded connection, pasting connection and the like, or alternatively, the regulating head 130 can be integral to the flow regulating rod 103. In addition, an end of the flow regulating rod 103 away from the outlet port is connected to a piston 110 in the gas pressure chamber 11.

It should be noted that adjusting the size of the outlet port 111 by the regulating head 130 can be performed in the following way: on the one hand, in non-coating phase, as shown in FIG. 3a, the regulating head 130 can completely run through the outlet port 111 so that the outlet port 111 can be completely closed as shown in FIG. 3b. On the other hand, in coating phase, when the flow regulating rod 103 moves in a direction away from the outlet port 111 (direction Z in FIG. 3a), the opening size of the outlet port 111 can be controlled. Specifically, the regulating head 130 can be designed as a structure tapering from top to bottom, that is, the cross section area of an end of the regulating head 130 near the flow regulating rod 103 is larger, while the cross section area of an end of the regulating head 130 away from the flow regulating rod 103 is smaller. The cross section of the regulating head 130 is a cross section of the flow regulating rod 103 taken in a direction normal to the extending direction of the flow regulating rod 103 (e.g., along the O-O′ direction in FIG. 3a).

Because the regulating head 130 has a structure tapering from top to bottom, the lager the displacement of the flow regulating rod 103 in the direction away from the outlet port 111, the higher the flow rate of the material flowing through the outlet port 11 in opening state, and vice versa. For example, the outlet ports 11 in FIG. 4a and FIG. 4b both are in opening state; however, the blocked area in the outlet port 111 by the regulating head 130 in FIG. 4a is smaller so that more material can pass through the outlet port 111 than in FIG. 4b. That is to say, the opening of the outlet port 111 in FIG. 4a is larger than the opening of the outlet port 111 in FIG. 4b. In such case, accordingly, the displacement of the flow regulating rod 103 in the direction away from the outlet port 11 (in Z direction) in FIG. 4a is larger than the displacement of the flow regulating rod 103 in the direction away from the outlet port 111 (in Z direction) in FIG. 4b.

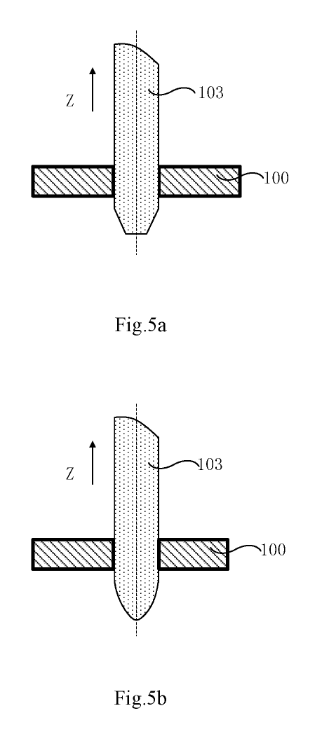

Besides, in order that the regulating head 130 have the structure tapering from top to bottom, the longitudinal cross-section of the regulating head 130 can be in triangular shape as shown in FIG. 3a or in inverted trapezoidal shape as shown in FIG. 5a or in circular arc shape as shown in FIG. 5b, which is not limited herein as long as the further the flow regulating rod 103 moves in the direction away from the Z direction, the larger the opening of the outlet port 111. In this context, the longitudinal cross-section of the regulating head 130 is a cross section perpendicular to the cross section of the regulating head 130.

To sum up, the above mentioned regulating head 130 has a solid structure. However, the regulating head 130 may has a hollow structure, such as tubular structure. In this case, as shown in FIG. 5c, the side wall of the regulating head 130 is provided with a regulating hole 114. By controlling the displacement of the flow regulating rod 103 in the direction Z away from outlet port 11, the amount of the material flowing from the storage chamber 100 through the regulating hole 114 can be adjusted, thereby realizing the purpose of adjusting the material flow rate. Exemplarily, the regulating head 130 can be a cylinder as shown in FIG. 5c.

On this basis, the output of the gas pressure regulating device 20 is connected to the gas pressure chamber 11 and the input of the gas pressure regulating device 20 is connected to the gas supply source 30. The gas pressure regulating device 20 can receive the preset material flow rate of the outlet port 111 and then convert it into a preset gas pressure value of the gas pressure chamber 11 matching with the preset material flow rate and then control the flow of the gas outputted from the gas supply source 30 to the gas pressure chamber 11 based on the preset gas pressure value so that the gas from the gas supply source 30 through the gas pressure regulating device 20 to the gas pressure chamber 11 can have the preset gas pressure value.

It should be noted that the matching between the preset gas pressure value and the preset material flow rate is exemplarily as follows: when the preset material flow rates are ¼Q, ½Q and ¾Q (Q is the material flow rate when the outlet port 111 is completely open) respectively, the preset gas pressure value matching with the preset material flow rate ¼Q is low pressure 0.01 MPa; the preset gas pressure value matching with the preset material flow rate ½Q is medium pressure 0.02 MPa; and the preset gas pressure value matching with the preset material flow rate ¾Q is medium pressure 0.03 MPa.

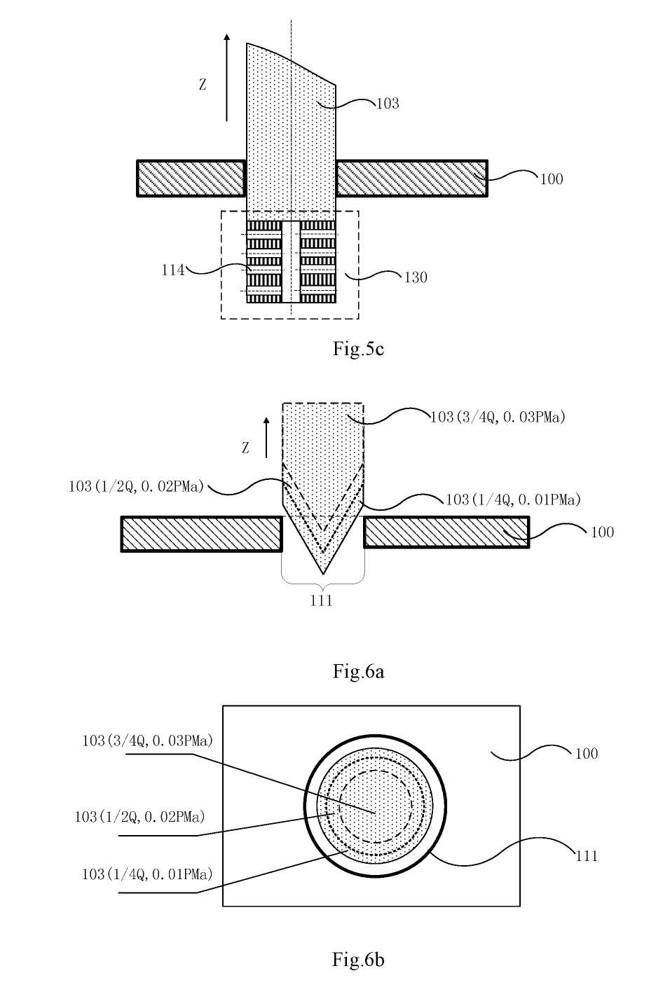

In this case, when flow rate ¼Q is required, the operator can input the preset material flow rate ¼Q to the gas pressure regulating device 20, then the gas pressure regulating device 20 can control the gas outputted from the gas supply source 30 to the gas pressure chamber 11 to be at a low pressure 0.01 MPa so that the preset material flow rate ¼Q can be matched with the preset gas pressure value 0.01 MPa. At this time, under the action of the preset material flow rate ¼Q, the outlet port 111 can be in a ¼ opening state. Similarly, the preset gas pressure value ½Q can be matched with the preset material flow rate 0.02 MPa and under the action of the preset material flow rate ½Q, the outlet port 111 can be in a ½ opening state; and the preset gas pressure value ¾Q can be matched with the preset material flow rate 0.03 MPa and under the action of the preset material flow rate ¾Q, the outlet port 111 can be in a ¾ opening state. Specifically, as can be seen in FIG. 6a, the higher the preset material flow rate, the larger the preset gas pressure value and the larger the displacement of the flow regulating rod 103 in the direction Z away from the outlet port 111. In this case, as shown in FIG. 6b, the larger the preset gas pressure value, the larger the opening of the outlet port 111, and the higher the material flow rate of the outlet port 111. Thus it can be seen that the gas pressure value is matched with the preset material flow rate.

Besides, the output of the gas pressure regulating device 20 is connected to the gas pressure chamber 11, as shown in FIG. 2, through a vent hole 112 in the side wall of the gas pressure chamber 11. Then the output of the gas pressure regulating device 20 can be connected to the vent hole 112 through a hose 113.

The piston 110 in the gas pressure chamber 11 can divide the gas pressure chamber 11 into a first chamber 01 and a second chamber 02. Therefore, the above mentioned vent hole 112 can be made in the side wall of the second chamber 02 or made in the side wall of the first chamber 01. In the case that the vent hole 112 is made in the side wall of the second chamber 02 as shown in FIG. 2, when the outlet port 111 is required to open, the flow regulating rod 103 can move in the direction Z away from the outlet port 111, then the gas pressure regulating device 20 can provide gas at positive pressure from the gas supply source 30 to the second chamber 02. Or alternatively, in the case that the vent hole 112 is made in the side wall of the first chamber 01, when the outlet port 111 is required to open, the flow regulating rod 103 can move in the direction Z away from the outlet port 111. At this time, the gas pressure regulating device 20 can provide gas at negative pressure from the gas supply source 30 to the first chamber 01 through the vent hole 112. Of course, the present disclosure does not restrict the position of the vent hole. However, for the convenience of illustration, the following embodiment is illustrated taking the vent hole 112 made in the side wall of the second chamber 02 as an example.

An embodiment of the present disclosure provides a material coating apparatus. The material coating apparatus includes a storage chamber, a gas pressure chamber, a flow regulating rod, a gas pressure regulating device and a gas supply source. Specifically, the flow regulating rod runs through the storage chamber and is provided with a regulating head at an end near the outlet port of the storage chamber which is used to adjust the size of the outlet port of the storage chamber, and an end of the flow regulating rod facing away from the outlet port is connected to a piston in the gas pressure chamber. The output of the gas pressure regulating device is connected to the gas pressure chamber; an input of the gas pressure regulating device is connected to the gas supply source and receives a preset material flow rate of the outlet port. The gas pressure regulating device is configured to convert the preset material flow rate into a preset gas pressure value of the gas pressure chamber matching with the preset material flow rate and then control the gas flow rate outputted from the gas supply source to the gas pressure chamber.

The regulating head can adjust the size of the outlet port, therefore in non-coating phase, the regulating head can close the outlet port. In coating phase, the flow regulating rod can move in the direction away from the outlet port, so that the regulating head can control the opening size of the outlet port. Specifically, the operator can input the preset material flow rate required in coating through the gas pressure regulating device, then the gas pressure regulating device can control the gas flow outputted from the gas supply source to the gas pressure chamber based on the preset material flow rate so that the gas outputted from the gas supply source through the gas pressure regulating device to the gas pressure chamber can have the above mentioned preset gas pressure value. Under the action of the gas with preset gas pressure value in the gas pressure chamber, the piston can be controlled to move the flow regulating rod in the direction away from the outlet port. Because the preset gas pressure value and the preset material flow rate are matched, the actual flow rate of the material through the outlet port is equal to or approximately equal to the preset material flow rate.

In this way, in the coating process of the material coating apparatus, the operator is only required to input the preset material flow rate manually, then the actual material flow rate of the outlet port can achieve the preset material flow rate, and there is no need to adjust the material flow rate manually so that the control accuracy of the coating flow can be improved and the probability of poor coating can be reduced. Besides, due to the increased control accuracy, the downtime caused by poor coating can be avoided and the production efficiency can be improved.

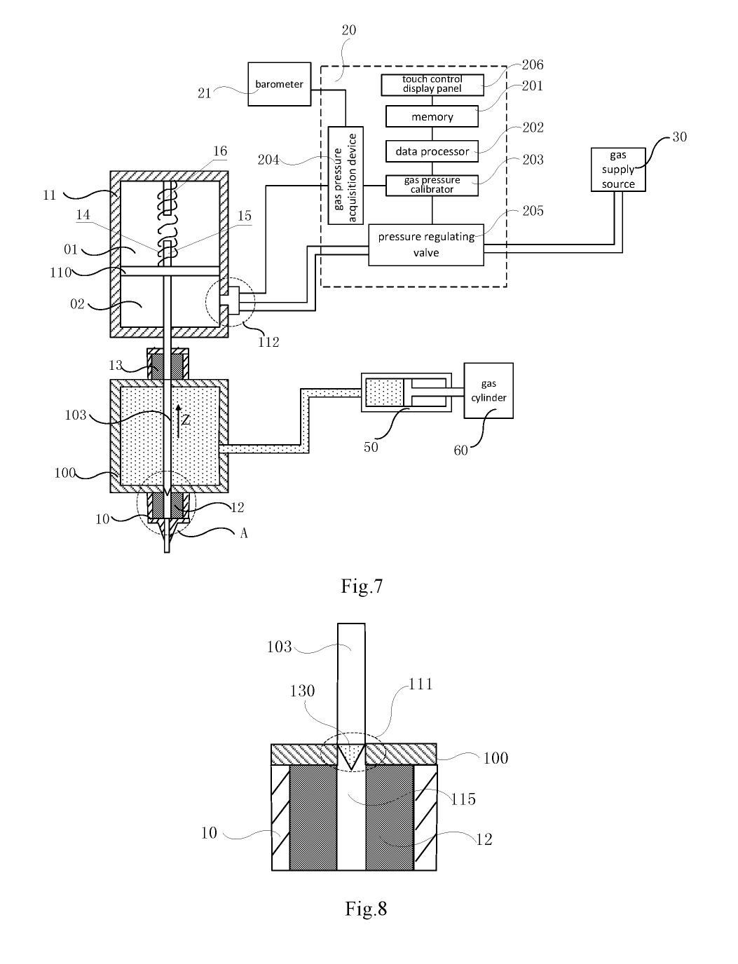

The following will describe the structure of the gas pressure regulating device 20 in detail. As shown in FIG. 7, the gas pressure regulating device 20 can includes a memory 201 and a data processor 202.

The memory 201 is used to store the preset material flow rate, the preset gas pressure value, and the matching relationship between the preset material flow rate and the preset gas pressure value. The data processor 202 is connected to the memory 201 and obtains the preset gas pressure value matching with the preset material flow rate based on the preset material flow rate. In this way, when the user inputs the preset material flow rate, the data processor 202 can directly invoke the preset gas pressure value matching with the preset material flow rate in the memory 201 by addressing access. In this way, when the working environment or condition of the material coating apparatus is changed, the operator can update and reset the preset material flow rate, the preset gas pressure value and the matching relationship between the preset material flow rate and the preset gas pressure value so as to meet different requirements.

On this basis, the gas pressure regulating device 20 further includes a pressure regulating valve 205 which is connected to the data processor 202, the gas supply source 30 and the gas pressure chamber 11. The pressure regulating valve 205 is used to control the flow rate of the gas outputted from the gas supply source 30 to the gas pressure chamber 11 based on the preset gas pressure value. However, in order to enable the actual gas pressure value inputted into the second chamber 02 through the vent hole 112 by the gas pressure regulating device 20 to equal to or approximately equal to the preset gas pressure value, the gas pressure in the second chamber 02 can be acquired and fed back to the gas pressure regulating device 20, so that the gas pressure outputted from the gas pressure regulating device 20 can be adjusted to cause the actual pressure value in the second chamber 02 to match the preset gas pressure value.

In order to realize the above function, as shown in FIG. 7, the gas pressure regulating device 20 includes a gas pressure acquisition device 204, a gas pressure calibrator 203 and a pressure regulating valve 205 connected to the vent hole 112 of the gas pressure chamber 11.

One end of the gas pressure acquisition device 204 is connected to the gas pressure chamber 11 through the above mentioned vent hole 112, the other end of the gas pressure acquisition device 204 is connected to the gas pressure calibrator 203. The gas pressure acquisition device 206 is used to acquire the gas pressure value in the gas pressure chamber 11 (that is, the second chamber 02 provided with a vent hole 112) through the vent hole 112 and feed it back to the gas pressure calibrator 203.

Besides, the description “the pressure regulating valve 205 is connected to the data processor 202” can mean that the pressure regulating valve 205 is connected to the data processor 202 through the gas pressure calibrator 203. The gas pressure calibrator 203 is used to receive the gas pressure value fed back by the gas pressure acquisition device 204 and calibrate the flow rate of the gas pressure outputted from the pressure regulating valve 205 based on the preset gas pressure value obtained by the data processor 202 so that the gas pressure value in the gas pressure chamber 11 is matched with the preset gas pressure value.

It should be noted that a comparator or a comparator circuit can be provided in the gas pressure calibrator 203. The comparator or a comparator circuit can compare the actual gas pressure value in the second chamber 02 acquired through the vent hole 112 and the preset gas pressure value obtained by the data processor 202 to facilitate the pressure regulating valve 205 to adjust the pressure of the output gas so that the actual gas pressure value in the second chamber 02 can be equal to or approximately equal to the preset gas pressure value.

Furthermore, as shown in FIG. 7, the material stored in the storage chamber 100 can be supplied by the material supply chamber 50 in FIG. 7. Specifically, one end of the material supply chamber 50 is connected to a gas cylinder 60, and the other end of the material supply chamber 50 is connected to the storage chamber 100. Under the action of the gas cylinder 60, the material supply chamber 50 can supply material to the storage chamber 100. In this way, the supply amount of the material to the storage chamber 100 can be precisely controlled by controlling the pressure of the input gas of the gas cylinder 60.

It should be noted that the gas species provided by the gas supply source 30 and the gas cylinder 60 are not limited. It can be air, inert gas and the like. The gas pressure provided by the gas supply source 30 and the gas cylinder 60 can be a constant value.

Furthermore, in order to directly observe the gas pressure value acquired by the gas pressure acquisition device 204, the material coating apparatus further includes a barometer 21. The barometer 21 is connected to the gas pressure acquisition device 204 and is used to display the gas pressure value acquired by the gas pressure acquisition device 204.

In addition, in order to facilitate the user to input the preset material flow rate into the gas pressure regulating device 20, the gas pressure regulating device further includes a touch control display panel 206 which is used to input and display the preset material flow rate. It should be noted that when the operator is not convenient to observe the barometer 21 because its restricted installation position and the like, the barometer 21 can be connected to the touch control display panel 206 so that the gas pressure value on the barometer 21 can be displayed on the touch control display panel 206.

Furthermore, in order to enable the material flowing out of the outlet port 111 to correspond to the position being coated, a nozzle 10 can be provided at the outlet port 111, which is connected to the outlet port 111. In addition, in order to avoid material leakage at the interface between the nozzle 10 and the outlet port 111, a first sealing plug 12 can be provided in the nozzle 10 at a position close to the outlet port. Moreover, to ensure the material can be ejected from the nozzle 10, the first sealing plug 12 is provided with a first through hole 115 at a position corresponding to the outlet port 111 to allow the material to pass (as shown in FIG. 8).

On this basis, a portion in FIG. 7 is shown in FIG. 8 in detail. It can be seen that the regulating head 130 is tapered. That is, as shown in FIG. 3a, when the longitudinal cross-section of the regulating head 130 is triangular, if the regulating head 130 is required to close the outlet port 111, the diameter of the interface between the regulating head 130 and the flow regulating rod 103 needs to be comparable to the inner diameter of the outlet port 111. However, in typical manufacturing process, due to manufacture tolerance, the regulating head 130 cannot close the outlet port 111 completely, resulting in material leakage.

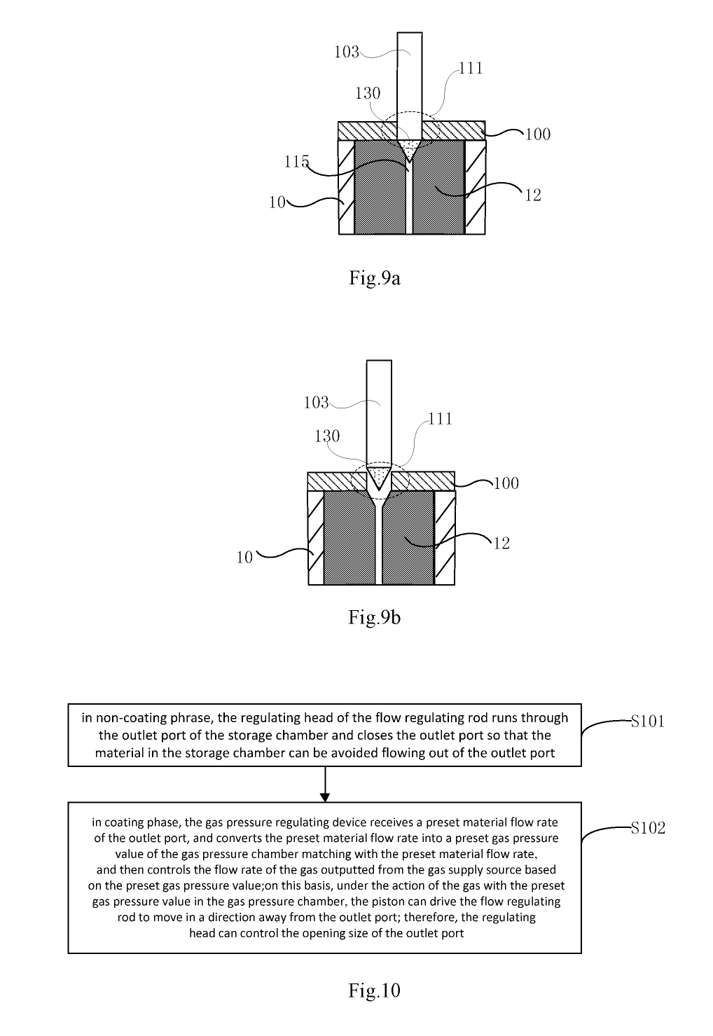

In order to solve the problem, as to the tapered regulating head 130, as shown in FIG. 9a, the first sealing plug 12 is at a side near the regulating head 130, and the opening shape of the first through hole 115 is inverted tapered. When the outlet port 111 is required to be closed, the first sealing plug 12 with inverted tapered shape can seal around the tapered regulating head 130 to avoid material leakage. The tapered shape of the regulating head 130 is matched with the inverted tapered shape of the first through hole 115.

In addition, when the outlet port 111 needs to open, as shown in FIG. 9b, the material can flow through the gap between the regulating head 130 and the outlet port 111 into the upper inverted tapered opening of the first through hole 115.

Furthermore, because the flow regulating rod 103 runs through the storage chamber 100, the flow regulating rod 10 located in the storage chamber 100 might adhere some material. When the piston 110 drive the flow regulating rod 103 to move in the direction Z away from the outlet port 111, the materials adhered on the surface of the flow regulating rod 10 will come out of the storage chamber 100 along with the flow regulating rod 10 so that other components in the material coating device might be contaminated. To solve the problem, there is a second sealing plug 13 at the outside of the storage chamber 100 at a position corresponding to the flow regulating rod 103. The second sealing plug 13 has a second through hole (not shown) to allow the flow regulating rod 103 to pass through. Moreover, when the coating process is finished, the gas supply source 30 will stop supplying gas to the gas pressure chamber 11. Then, the flow regulating rod 103 will move towards the outlet port 111 so that the outlet port 111 will be closed. In order to increase the closing speed of the outlet port 111 and avoid excess material leaking from the outlet port 111, as shown in FIG. 7, the piston is connected to a spring 14 at the side away from the flow regulating rod 103. The other end of the spring is connected to the top of the gas pressure chamber 11. In this way, during the coating process, the second chamber 02 is filled with gas, so that the piston 110 can move upwards (in Z direction) and compress the spring 14. However, when the coating process is finished, the filling gas in the second chamber 02 will be reduced or discharged, then the spring 14 in compressed state will be elastically restored so as to push the piston 110 to move downwards (opposite to the direction Z). In this way, the flow regulating rod 103 can close the outlet port 111 rapidly to avoid excess material flowing out.

On this basis, during compression of the spring 14, in order to avoid the elastic deformation of the spring 144 becoming unrecoverable due to excess pressure at two ends, as shown in FIG. 7, the piston 110 is provided with a first guide bar 15 at a side away from the flow regulating rod 103, and the top of gas pressure chamber 11 is provided with a second guide bar 16 opposite to the first guide bar 15. Moreover, the first guide bar 15 and the second guide bar 16 can penetrate in the spring 14 from two ends of the spring 14. When the first guide bar 15 and the second guide bar 16 contact with each other, the spring 14 can be prevented from being further compressed so that the unrecoverable elastic deformation of the spring 14 can be avoided. Furthermore, the first guide bar 15 and the second guide bar 16 can guide the spring 14 to avoid shaking during compression or extension.

An embodiment of the present disclosure provides a method of controlling any of the above mentioned material coating apparatuses, as shown in FIG. 10, including:

S101, in non-coating phrase, the regulating head 130 of the flow regulating rod 103 as shown in FIG. 3a can run through the outlet port 111 of the storage chamber 100 shown in FIG. 2 and close the outlet port 111 so that the material in the storage chamber 100 can be avoided flowing out of the outlet port 111.

S102, in coating phase, the gas pressure regulating device 20 shown in FIG. 2 can receive a preset material flow rate of the outlet port 111, and convert the preset material flow rate into a preset gas pressure value of the gas pressure chamber matching with the preset material flow rate and then control the flow rate of the gas outputted from the gas supply source 30 based on the preset gas pressure value;

on this basis, under the action of the gas with the preset gas pressure value in the gas pressure chamber 11, the piston 110 can drive the flow regulating rod 103 to move in a direction away from the outlet port 111; therefore, the regulating head 130 can control the opening size of the outlet port 111.

The regulating head can adjust the size of the outlet port. Therefore, in non-coating phase, the regulating head can close the outlet port. In coating phase, the flow regulating rod can move in the direction away from the outlet port, so that the regulating head can control the opening size of the outlet port. Specifically, the operator can input the preset material flow rate required in coating through the gas pressure regulating device, the gas pressure regulating device can control the gas flow outputted from the gas supply source to the gas pressure chamber based on the preset material flow rate so that the gas outputted from the gas supply source through the gas pressure regulating device to the gas pressure chamber can have the above mentioned preset gas pressure value. Under the action of the gas with preset gas pressure value in the gas pressure chamber, the piston can be controlled to move the flow regulating rod in the direction away from the outlet port. Because the preset gas pressure value and the preset material flow rate are matched, the actual flow rate of the material through the outlet port is equal to or approximately equal to the preset material flow rate.

In this way, in the coating process of the material coating apparatus, the operator is only required to input the preset material flow rate manually, the actual material flow rate of the outlet port can achieve the preset material flow rate, and there is no need to adjust the material flow rate manually so that the control accuracy of the coating flow can be improved and the probability of poor coating can be reduced. Besides, due to the increased control accuracy, the downtime caused by poor coating can be avoided and the production efficiency can be improved.

Furthermore, in order to enable the actual gas pressure value inputted into the second chamber 02 through the vent hole 112 shown in FIG. 7 by the gas pressure regulating device 20 to equal to or approximately equal to the preset gas pressure value, the gas pressure in the second chamber 02 can be acquired and fed back to the gas pressure regulating device 20, so that the gas pressure outputted from the gas pressure regulating device 20 can be adjusted to cause the actual pressure value in the second chamber 02 to match the preset gas pressure value.

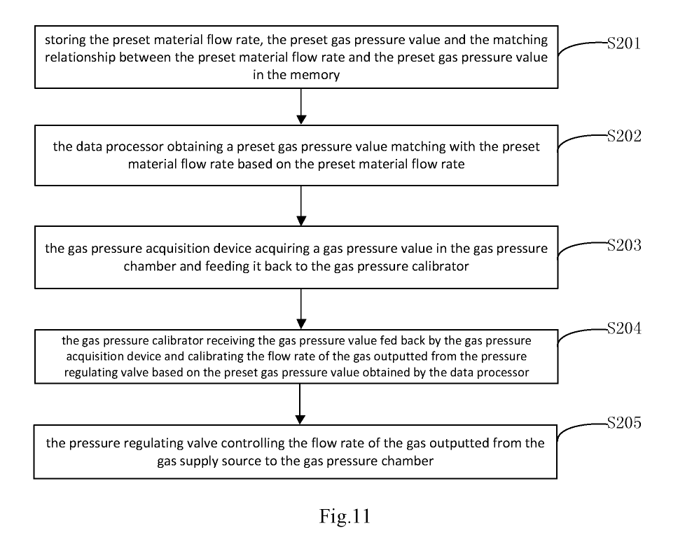

In order to realize the above functions, the gas pressure regulating device 20 shown in FIG. 7 includes the memory 201, the data processor 202, the gas pressure acquisition device 204, the gas pressure calibrator 203 and the pressure regulating valve 205. In the coating phase, the control method shown in FIG. 11 includes:

S201, storing the preset material flow rate, the preset gas pressure value and the matching relationship between the preset material flow rate and the preset gas pressure value in the memory 201;

S202, the data processor 202 obtaining a preset gas pressure value matching with the preset material flow rate based on the preset material flow rate;

S203, the gas pressure acquisition device 204 acquiring a gas pressure value in the gas pressure chamber 11 and feeding it back to the gas pressure calibrator 203;

S204, the gas pressure calibrator 203 receiving the gas pressure value fed back by the gas pressure acquisition device 204 and calibrating the flow rate of the gas outputted from the pressure regulating valve 205 based on the preset gas pressure value obtained by the data processor 202 so that the gas pressure value in the gas regulating valve 205 can be matched with the preset gas pressure value;

S205, the pressure regulating valve 205 controlling the flow rate of the gas outputted from the gas supply source 30 to the gas pressure chamber 11 so that gas inputted into the gas pressure chamber 11 from the gas supply source 30 through the gas pressure regulating device 20 can have the above preset gas pressure value.

In summary, in the above steps, the gas pressure in the second chamber 02 can be acquired and fed back to the gas pressure regulating device 20 which will adjust the gas pressure inputted to the gas pressure chamber 11 so that the actual gas pressure value in the second chamber 02 will be matched with the above preset gas pressure value.

Moreover, the material coating apparatus and its control method according to the present disclosure are not limited to the field of display manufacture and they can also apply to other industrial apparatuses and other manufacture processes needing coating materials.

The above description is only exemplary embodiments of the present disclosure. However, the scope of the present disclosure is not restricted to those embodiments. Within the technical scope disclosed herein, various variations, substitutions or improvement will occur to those skilled in the art within the scope of the present disclosure. Therefore, the protection scope of the present disclosure should be the protection scope of the claims.

1. A material coating apparatus comprising: a storage chamber for containing the material; a flow regulating rod running through the storage chamber; a gas pressure chamber; a gas pressure regulating device and a gas supply source;
wherein the flow regulating rod is provided with a regulating head at an end near an outlet port of the storage chamber, wherein the regulating head adjusts the size of the outlet port; an end of the flow regulating rod facing away from the outlet port is connected to a piston in the gas pressure chamber;
wherein an output of the gas pressure regulating device is connected to the gas pressure chamber; an input of the gas pressure regulating device is connected to the gas supply source and receives a preset material flow rate of the outlet port; the gas pressure regulating device is configured to convert the preset material flow rate into a preset gas pressure value of the gas pressure chamber matching with the preset material flow rate, and to control a gas flow rate outputted from the gas supply source to the gas pressure chamber according to the preset gas pressure value.

2. The material coating apparatus according to claim 1, wherein the gas pressure regulating device comprises a memory, a data processor, and a pressure regulating valve;
wherein the memory stores the preset material flow rate, the preset gas pressure value and a matching relationship between the preset material flow rate and the preset gas pressure value;
wherein the data processor is connected to the memory, and is configured to obtain the preset gas pressure value matching with the preset material flow rate based on the preset material flow rate;
wherein the pressure regulating valve is connected to the data processor, the gas supply source and the gas pressure chamber, and is configured to control the gas flow rate outputted from the gas supply source to the gas pressure chamber based on the preset gas pressure value.

3. The material coating apparatus according to claim 2, wherein the gas pressure regulating device further comprises a gas pressure acquisition device and a gas pressure calibrator;
wherein one end of the gas pressure acquisition device is connected to the gas pressure chamber and the other end of the gas pressure acquisition device is connected to the gas pressure calibrator; the gas pressure acquisition device is used to acquire a gas pressure value in the gas pressure chamber and feed it back to the gas pressure calibrator;
the pressure regulating valve connects with the data processor through the gas pressure calibrator; the gas pressure calibrator receives the gas pressure value fed back by the gas pressure acquisition device and calibrates a flow rate of an output gas pressure of the pressure regulating valve based on the preset gas pressure value obtained by the data processor so that the gas pressure value in the gas pressure chamber is matched with the preset gas pressure value.

4. The material coating apparatus according to claim 3, further comprising a barometer connected to the gas pressure acquisition device, wherein the barometer displays the gas pressure value acquired by the gas pressure acquisition device.

5. The material coating apparatus according to claim 1, wherein the gas pressure regulating device further comprises a touch control display panel that inputs and displays the preset material flow rate.

6. The material coating apparatus according to claim 1, further comprising a gas cylinder and a material supply chamber;
wherein one end of the material supply chamber is connected to the gas cylinder, the other end of the material supply chamber is connected to the storage chamber, and the material supply chamber is supplies material to the storage chamber by the action of the gas cylinder.

7. The material coating apparatus according to claim 1, further comprising a nozzle connected to the outlet port, wherein the nozzle has a first sealing plug at a side near the outlet port; and wherein the first sealing plug has a first through hole for passing material at a position corresponding to the outlet port.

8. The material coating apparatus according to claim 7, wherein
the regulating head is tapered;
at a side near the regulating head, the opening of the first through hole is inverted tapered, and the tapered shape matches the inverted tapered shape.

9. The material coating apparatus according to claim 1, wherein the regulating head is a tubular structure and the regulating head has a regulating hole in a side wall thereof.

10. The material coating apparatus according to claim 1, wherein the storage chamber has a second sealing plug at an outside thereof at a position corresponding to the flow regulating rod, and the second sealing plug has a second trough hole which can allow the flow regulating rod to pass through.

11. The material coating apparatus according to claim 1, wherein the piston is connected to a spring at a side facing away from the flow regulating rod, the other end of the spring is connected to a top of the gas pressure chamber.

12. The material coating apparatus according to claim 11, wherein the piston has a first guide bar at a side facing away from the flow regulating rod; the top of the gas pressure chamber has a second guide bar opposite to the first guide bar;
the first guide bar and the second guide bar extend into the spring at two ends of the spring, which are used to stop the spring from being further compressed when the first guide bar and the second guide bar contact each other.

13. A method of controlling a material coating apparatus, wherein the material coating apparatus comprises: a storage chamber for containing the material; a flow regulating rod running through the storage chamber; a gas pressure chamber; a gas pressure regulating device and a gas supply source;
wherein the flow regulating rod includes a regulating head at an end near an outlet port of the storage chamber, wherein the regulating head adjusts the size of the outlet port; an end of the flow regulating rod facing away from the outlet port is connected to a piston in the gas pressure chamber;
wherein an output of the gas pressure regulating device is connected to the gas pressure chamber; an input of the gas pressure regulating device is connected to the gas supply source and receives a preset material flow rate of the outlet port; the gas pressure regulating device is configured to convert the preset material flow rate into a preset gas pressure value of the gas pressure chamber matching with the preset material flow rate, and to control a gas flow rate outputted from the gas supply source to the gas pressure chamber according to the preset gas pressure value,
the method comprising the following steps:
in a non-coating phrase, using the regulating head of the flow regulating rod to run through the outlet port of the storage chamber and close the outlet port;
in a coating phase, using the gas pressure regulating device to receive a preset material flow rate of the outlet port, and convert the preset material flow rate into the preset gas pressure value of the gas pressure chamber which is matched with the preset material flow rate and then controls the flow rate of the gas outputted from the gas supply source based on the preset gas pressure value;
under the action of the gas with the preset gas pressure value in the gas pressure chamber, using the piston to drive the flow regulating rod to move in a direction away from the outlet port; the regulating head can control an opening size of the outlet port.

14. The method of controlling the material coating apparatus according to claim 13, wherein when the gas pressure regulating device comprises a memory, a data processor, a gas pressure acquisition device, a gas pressure calibrator and a pressure regulating valve, in the coating phase, the method comprises the following steps:
storing the preset material flow rate, the preset gas pressure value and a matching relationship between the preset material flow rate and the preset gas pressure value in the memory;
using the data processor to obtain the preset gas pressure value matching with the preset material flow rate based on the preset material flow rate;
using the gas pressure acquisition device to acquire the gas pressure value in the gas pressure chamber and feeding it back to the gas pressure calibrator;
using the gas pressure calibrator to receive the gas pressure value fed back by the gas pressure acquisition device and calibrating the flow rate of the gas outputted from the pressure regulating valve based on the preset gas pressure value obtained by the data processor;
using the pressure regulating valve to control the flow rate of the gas outputted from the gas supply source to the gas pressure chamber.
